(19) United States
(12) Patent Application Publication
(10) Pub. No.: US 2012/0166243 A1
(43) Pub. Date: Jun. 28, 2012

(54) FIELD SERVICE MANAGEMENT SYSTEMS AND METHODS

(76) Inventors: Brian V. Belmont, West Linn, OR (US); Jurgen Hatheier, Beaverton, OR (US); Michael P. Gordish, Huntersville, NC (US); Kishor G. Yadav, Portland, OR (US); Steven Cardenas, Beaverton, OR (US)

(21) Appl. No.: 12/979,109

(22) Filed: Dec. 27, 2010

(51) Int. Cl. G06Q 10/00

(52) U.S. Cl. 705/7.13

(57) ABSTRACT

Methods and apparatuses for scheduling a task using field data are provided. Field data can be used to more accurately predict and continually adjust the estimated amount of time to complete a work order when scheduling resources.

### TECHNICAL FIELD

This disclosure relates to field service management.

### BACKGROUND

To maximize efficiencies, improve revenues, and enhance customer satisfaction, field service companies (e.g., companies that send technicians to consumer premises to install, service, repair, upgrade, etc. equipment) must, efficiently manage the resources (e.g., technicians) available to complete work orders. Scheduling is a key aspect of workforce management, and in particular, field service management. Poor scheduling can result in overtime costs, low utilization of staff, inefficient allocation of resources, and poor customer service. For example, if the time to complete a work order is underestimated, then there will be inadequate time scheduled for the technician to complete the work order before the technician's next scheduled work order. This underestimation can result in the technician being late for one or more subsequently scheduled work orders, which in turn can result in overtime costs and customer dissatisfaction. If the time to complete a work order is overestimated, then there can be non-productive idle time until the next scheduled work order.

Workforce management technologies (e.g., software applications) have been developed to attempt to assist companies in effectively scheduling resources. However, these existing technologies are not optimal or robust in that they do not use field data to schedule work orders. For example, existing technologies do not use field data to accurately predict the amount of time needed for a work order.

Thus, there is a need for improved field service management systems and methods that can more accurately schedule work orders including more accurately predict the amount of time needed to complete a work order.

### BRIEF DESCRIPTION OF THE DRAWINGS

FIG. 1 illustrates an example field service management system for scheduling and routing work orders.

FIG. 2 illustrates an example field service management system for scheduling work orders using field data.

FIG. 3 illustrates an example field service management process for the field service management system of FIG. 2.

FIG. 4 illustrates an example resource engine of FIG. 2 operable to perform the example process of FIG. 3.

### DETAILED DESCRIPTION

Various implementations of this disclosure use field data to more accurately predict and continually adjust the estimated amount of time to complete a work order when scheduling resources.

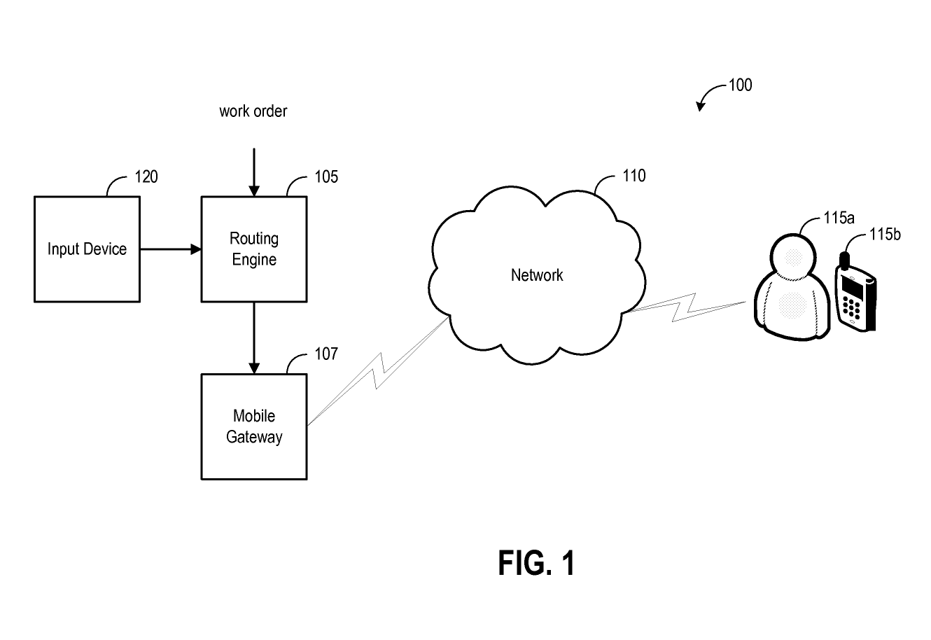

FIG. 1 illustrates an example field service management system 100 for scheduling and routing work orders. A routing engine 105 receives a work order and schedules and routes the work order via a mobile gateway 107 and network 110 to a mobile device 115b of a field service technician 115a. The routing engine 105 can receive the work order from one or more work order generation sources. A work order can be generated manually or automatically. The technician 115a can view the work order and corresponding schedule via the mobile device 115b.

The routing engine 105 can assign and schedule work orders based on a number of variables. These variables can include technician proficiency/level of expertise, technician work schedule, technician routing area, estimated job duration (e.g., time to complete work order once technician is onsite), or any other factor. Factors such as technician proficiency and estimated job duration are provided manually to the routing engine 105 via an input device 120 (e.g., a keyboard). Generally, technician proficiency is based on crude classifications. Technician proficiency remains constant until changed manually. Similarly, estimated job duration can be based on a rough estimate and remains constant until changed manually. Existing routing engines do not use data collected from the field to compute technician proficiency or estimated job duration.

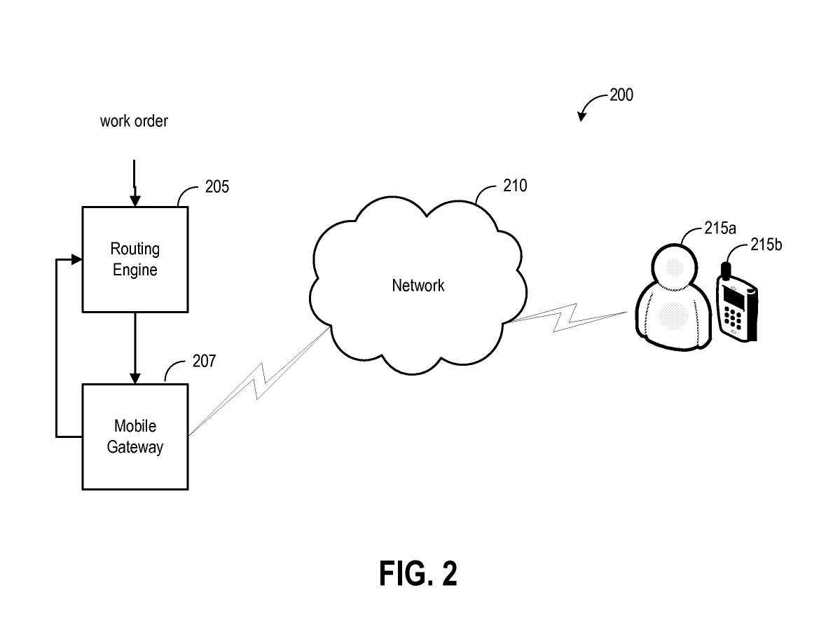

FIG. 2 illustrates an example field service management system 200 for scheduling and routing work orders using field data. More specifically, the field service management system 200 uses field data stored, for example, in the mobile gateway 207 to more accurately predict the amount of time needed for a work order. In particular, the field service management system 200 can use field data to compute technician proficiency and estimated job duration to more accurately predict the amount of time needed for a work order when assigned to a certain technician. In the field service management system 200, the technician 215a provides information such as work order status information to a mobile gateway 207 via a mobile device 215b and network 110, for example. The information can include job start time and job completion time, for example. The routing engine 205 can use this information to more accurately predict and continually adjust the estimated amount of time to complete a work order when scheduling resources.

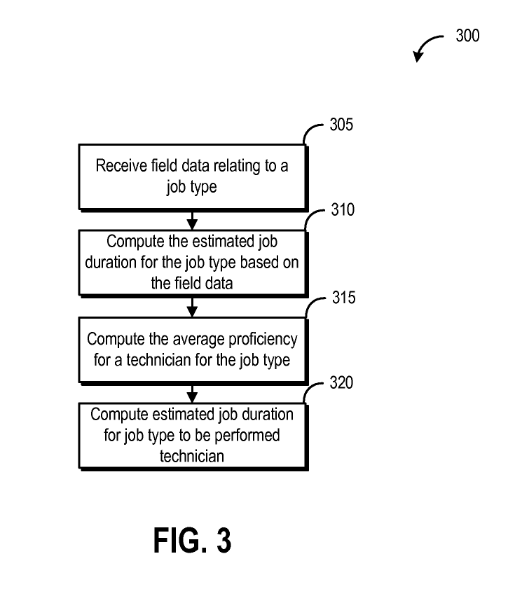

FIG. 3 illustrates an example field service management process 300 for the routing engine 205 of FIG. 2 for scheduling and routing a work order using field data for a particular job type, Jⱼ.

At stage 305, the routing engine 205 receives field data relating to work orders for job type, Jⱼ. In some implementations, the field data is received from the mobile gateway 205. In some implementations, the field data may be stored in another storage device. The field data may relate to information for one or more completed work orders for job type, Jⱼ. For example, information for a work order may include the job type (e.g., installations, repair, etc.), the “job start time”, the “job completion time”, and information to identify the technician that completed the work order, for example. For this discussion, it will be assumed that there are N technicians that have completed work orders for job type, Jⱼ.

At stage 310, based on the field data received, the routing engine 205 computes the estimated job duration for job type, Jⱼ (i.e., estimated job duration(Jⱼ)).

In some implementations, the routing engine 205 computes the estimated job duration for a job type, Jⱼ, by first computing for each technician, Tᵢ, i=1, . . . N, that has completed a work order for job type, Jⱼ, the average actual job duration for job type, Jⱼ, (i.e., average actual job duration(J_{J},Tᵢ)) The average actual job duration for a technician for a particular job type is computed based on data collected from the field for one or more work orders, WOₖ, k=1, . . . M, for the particular job type. Thus, in some implementations, for a job type, Jⱼ, the routing engine 205 can compute the average actual job duration for a technician, Tᵢ, using the following equation:

$$average actual job duration ( {J}_{J} , {T}_{i} ) = \frac{{\sum }_{{WO}_{1}}^{{WO}_{M}} actual job duration ( {J}_{J} , {T}_{i} , {WO}_{k} )}{number of work orders}$$

where Σ_{WO}_{₁}^{WO}^{_{M}} actual job duration(J_{J},Tᵢ,WOₖ) is the sum of the actual job duration for each work order, WOₖ, for job type, Jⱼ, completed by the technician, Tᵢ and the number of work orders equal M.

The actual job duration(J_{J},Tᵢ,WOₖ) can be computed based on field data “job start time” and the “job completion time” collected for a work order. More specifically, the actual job duration(J_{J},Tᵢ,WOₖ) can be equal to the job completion time(J_{J},Tᵢ,WOₖ)−job start time(J_{J},Tᵢ,WOₖ) for work order, WOₖ, for job type, Jⱼ, completed by the technician, Tᵢ.

To compute the estimated job duration for job type, Jⱼ, routing engine 205 then can sum the average actual job duration for job type, Jⱼ, for each technician, Tᵢ, i=1, . . . N, (i.e., average actual job duration(Jⱼ,Tᵢ)), and divide the sum by the number of technicians. That is, routing engine 205 can compute the estimated job duration for a job type, Jⱼ, using the following equation:

$$estimated job duration ( {J}_{j} ) = \frac{{\sum }_{{T}_{1}}^{{T}_{N}} average actual job duration ( {J}_{J} , {T}_{i} )}{number of technicians}$$

At stage 315, the routing engine 205 can compute an average proficiency for a technician, Tᵢ, for a job type, Jⱼ, using the following equation:

$$average proficiency ( {J}_{j} , {T}_{i} ) = \frac{estimated job duration ( {J}_{j} )}{average actual job duration ( {J}_{j} , {T}_{i} )} \times 100$$

At stage 320, the routing engine 205 can compute the estimated job duration for job type, Jⱼ, to be performed by technician, Tᵢ, using the following equation:

$$estimated job duration ( {J}_{j} , {T}_{i} ) = \frac{estimated job duration ( {J}_{j} )}{average proficiency ( {J}_{j} , {T}_{i} )} \times 100$$

This process 300 can be repeated for each job type and for each technician.

By using data collected from the field to compute the estimated job duration for a particular job type, Jⱼ, (i.e., estimated job duration(Jⱼ)), and the average proficiency of a technician, Tᵢ, for a particular job type, Jⱼ, (i.e., average proficiency(Jⱼ,Tᵢ)), the routing engine 205 can make more accurate decisions when scheduling work orders. For example, the routing engine 205 can more accurately estimate the amount of time it would take a particular technician, Tᵢ, to complete a particular job type, Jⱼ.

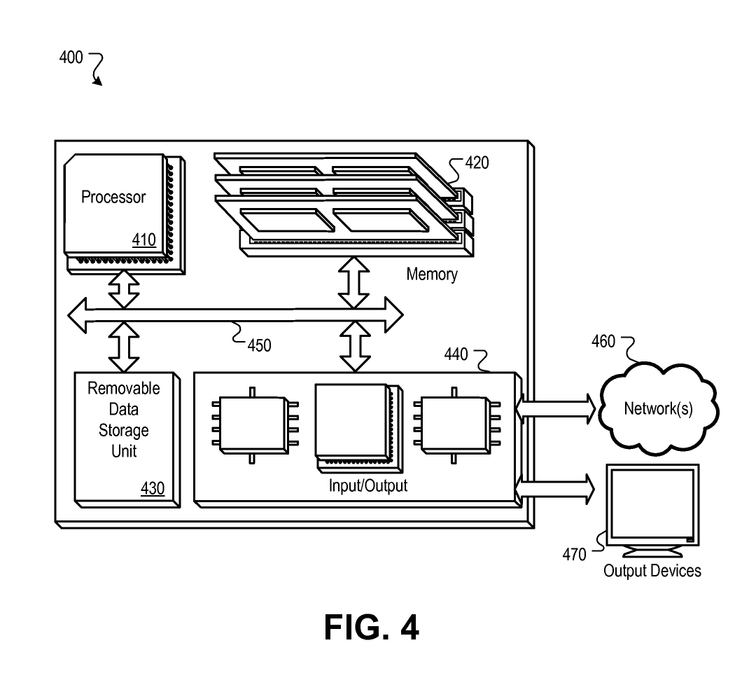

FIG. 4 illustrates an example resource engine 205 operable to perform the example process 300 of FIG. 3.

The resource engine 205 can include a processor 410, a memory 420, a removable data storage unit 430, and an input/output device 440. Each of the components 410, 420, 430, and 440 can, for example, be interconnected using a system bus 450. The processor 410 is capable of processing instructions for execution within the resource engine 205. For example, the processor 410 can be capable of processing instructions for executing the process 300 of FIG. 3 in resource engine 205. In some implementations, the processor 410 is a single-threaded processor. In other implementations, the processor 410 is a multi-threaded processor. The processor 410 is capable of processing instructions stored in the memory 420 or on the storage device 430.

The memory 420 stores information within the resource engine 205. For example, resource engine 205 may store the field data and/or work orders received or the schedule generated. In some implementations, the memory 420 is a computer-readable medium. In other implementations, the memory 420 is a volatile memory unit. In still other implementations, the memory 420 is a non-volatile memory unit.

Implementations of the device of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, implementations of the subject matter described in this specification can be operable to interface with a computing device having a display, e.g., a CRT (cathode ray tube) or LCD (liquid crystal display) monitor, for displaying information to the user and a keyboard and a pointing device, e.g., a mouse or a trackball, by which the user can provide input to the computer.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

1. A method for scheduling a task using field data, the method comprising:
receiving field data relating to one or more completed task, where the one or more completed tasks are classified as a first job type;
computing a time duration for a task to be scheduled based on the field data received, wherein the task to be scheduled is classified as the first job type; and
computing, for each resource of one or more resources, a time duration for the resource based on the field data received.

2. The method of claim 1 wherein the field data includes start time and completion time for each of the one or more completed task.

3. The method of claim 2 wherein computing a time duration for a task to be scheduled based on the field data received comprises computing a time to complete the task to be scheduled based on the field data received.

4. The method of claim 2 wherein the time duration for a task to be scheduled is based on a time duration of one or more of the completed tasks.

5. The method of claim 2 wherein computing a time duration for a task to be scheduled based on the field data comprises computing
$$\frac{{\sum }_{{T}_{1}}^{{T}_{N}} average actual job duration ( {J}_{J} , {T}_{i} )}{N}$$
where
$$average actual job duration ( {J}_{J} , {T}_{i} ) = \frac{{\sum }_{{WO}_{1}}^{{WO}_{M}} actual job duration ( {J}_{J} , {T}_{i} , {WO}_{k} )}{M} ;$$
where Σ_{WO}_{₁}^{WO}^{_{M}} actual job duration(J_{J},Tᵢ,WOₖ) is the sum of the actual job duration for each of the one or more completed task, WOₖ, for the first job type, Jⱼ, completed by resource, Tᵢ;
where actual job duration(J_{J},Tᵢ,WOₖ)=job completion time(J_{J},Tᵢ,WOₖ)−job start time (J_{J},Tᵢ,WOₖ) for work order, WOₖ, for job type, Jⱼ, completed by the resource, Tᵢ;
where M is the number of completed tasks; and
where N is the number of resources.

6. The method of claim 5 wherein the resources Tᵢ, i=1, N are one or more technicians that performed work on the one or more completed tasks.

7. The method of claim 1 wherein computing, for each resource of one or more resources, a time duration for the resource based on the field data received comprises computing, for each resource of one or more resources, a time to complete the task to be scheduled by the resource based on the field data received.

8. The method of claim 7 wherein computing, for each resource of one or more resources, a time duration for the resource based on the field data received comprises computing
$$\frac{{\sum }_{{WO}_{1}}^{{WO}_{M}} actual job duration ( {J}_{J} , {T}_{i} , {WO}_{k} )}{M}$$
where Σ_{WO}_{₁}^{WO}^{_{M}} actual job duration(J_{J},Tᵢ,WOₖ) is the sum of the actual job duration for each of the one or more completed task, WOₖ, for the first job type, Jⱼ, completed by the resource, Tᵢ;
where actual job duration(J_{J},Tᵢ,WOₖ)=job completion time(J_{J},Tᵢ,WOₖ)−job start time(J_{J},Tᵢ,WOₖ) for work order, WOₖ, for job type, Jⱼ, completed by the resource, Tᵢ; and
where M is the number of completed tasks.

9. The method of claim 8 wherein the resource is a technician.

10. A computer readable medium having instructions for causing a computer to execute a method for scheduling a task using field data, the method comprising:
receiving field data relating to one or more completed task, where the one or more completed tasks are classified as a first job type;
computing a time duration for a task to be scheduled based on the field data received, wherein the task to be scheduled is classified as the first job type; and
computing, for each resource of one or more resources, a time duration for the resource based on the field data received.

11. The computer readable medium of claim 10 wherein the field data includes start time and completion time for each of the one or more completed task.

12. The computer readable medium of claim 11 wherein computing a time duration for a task to be scheduled based on the field data received comprises computing a time to complete the task to be scheduled based on the field data received.

13. The computer readable medium of claim 11 wherein the time duration for a task to be scheduled is based on a time duration of one or more of the completed tasks.

14. The computer readable medium of claim 11 wherein computing a time duration for a task to be scheduled based on the field data comprises computing
$$\frac{{\sum }_{{T}_{1}}^{{T}_{N}} average actual job duration ( {J}_{J} , {T}_{i} )}{N}$$
where average actual job duration
$$( {J}_{J} , {T}_{i} ) = \frac{{\sum }_{{WO}_{1}}^{{WO}_{M}} actual job duration ( {J}_{J} , {T}_{i} , {WO}_{k} )}{M} ;$$
where Σ_{WO}_{₁}^{WO}^{_{M}} actual job duration(J_{J},Tᵢ,WOₖ) is the sum of the actual job duration for each of the one or more completed task, WOₖ, for the first job type, Jⱼ, completed by resource, Tᵢ;
where actual job duration(J_{J},Tᵢ,WOₖ)=job completion time(J_{J},Tᵢ,WOₖ)−job start time(J_{J},Tᵢ,WOₖ) for work order, WOₖ, for job type, Jⱼ, completed by the resource, Tᵢ;
where M is the number of completed tasks; and
where N is the number of resources.

15. The computer readable medium of claim 14 wherein the resources Tᵢ, i=1, N are one or more technicians that performed work on the one or more completed tasks.

16. The computer readable medium of claim 10 wherein computing, for each resource of one or more resources, a time duration for the resource based on the field data received comprises computing, for each resource of one or more resources, a time to complete the task to be scheduled by the resource based on the field data received.

17. The computer readable medium of claim 16 wherein computing, for each resource of one or more resources, a time duration for the resource based on the field data received comprises computing
$$\frac{{\sum }_{{WO}_{1}}^{{WO}_{M}} actual job duration ( {J}_{J} , {T}_{i} , {WO}_{k} )}{M}$$
where Σ_{WO}_{₁}^{WO}^{_{M}} actual job duration(J_{J},Tᵢ,WOₖ) is the sum of the actual job duration for each of the one or more completed task, WOₖ, for the first job type, Jⱼ, completed by the resource, Tᵢ;
where actual job duration(J_{J},Tᵢ,WOₖ)=job completion time(J_{J},Tᵢ,WOₖ)−job start time(J_{J},Tᵢ,WOₖ) for work order, WOₖ, for job type, Jⱼ, completed by the resource, Tᵢ; and
where M is the number of completed tasks.

18. The computer readable medium of claim 17 wherein the resource is a technician.

19. A system for scheduling a task using field data, the system comprising:
means for receiving field data relating to one or more completed task, where the one or more completed tasks are classified as a first job type;
means for computing a time duration for a task to be scheduled based on the field data received, wherein the task to be scheduled is classified as the first job type; and
means for computing, for each resource of one or more resources, a time duration for the resource based on the field data received.

20. A system for scheduling a task using field data, the system comprising:
a mobile gateway for receiving field data relating to one or more completed tasks, where the one or more completed tasks are classified as a first job type; and
a routing engine configured to compute a time duration for a task to be scheduled based on the field data received wherein the task to be scheduled is classified as the first job type and configured to compute, for each resource of one or more resources, a time duration for the resource based on the field data received
